(19) United States
(12) Patent Application Publication
(10) Pub. No.: US 2012/0294427 A1
(43) Pub. Date: Nov. 22, 2012

(54) METHOD FOR REMOVING MOTION FROM NON-CT SEQUENTIAL X-RAY IMAGES

(76) Inventor: John K. Grady, Harvard, MA (US)

(21) Appl. No.: 13/110,383

(22) Filed: May 18, 2011

(51) Int. Cl. H05G 1/60

(52) U.S. Cl. 378/95

(57) ABSTRACT

Applicant has disclosed a method for removing motion from non-CT cardiac angiographic or fluoroscopic x-ray 2-D sequential images, without using data prediction techniques in sequential CT imagery. Applicant's results are achieved by actively deleting or skipping exposure of certain 2-D flash image acquisitions during rapid heart motion (e.g., beating), the latter to reduce x-ray exposure. Applicant's preferred method comprises: positioning a person relative to a non-CT type x-ray machine, designed for fluoroscopy or angiography, with the person's heart between an x-ray source and a detector; monitoring rapid movement of the person's heart by electrocardiography; generating a series of x-ray pulses from the x-ray source; actively skipping any x-ray pulses by switching off the x-ray source during beating of the person's heart to prevent any images being generated from the skipped x-ray pulses; and generating sequential (i.e., either angiographic or fluoroscopic) 2-D cardiac images from the non-skipped x-ray pulses; wherein the motion is removed from the sequential images without using predictive algorithms and without using estimated compensation of motion.

### FIELD OF INVENTION

The present invention relates generally to x-ray machines. More particularly, it relates to non-CT cardiac angiographic or fluoroscopic x-ray 2-D sequential images.

### BACKGROUND OF INVENTION

The problem of acquiring sharp x-ray fluoroscopy images of the heart, to enable cardiac interventions via catheter (e.g., stents or diagnosis) has a long history of innovation geared toward sharper, non-blurred images.

Because the heart can move up to 400 mm/second in its most rapid phase, normal continuous fluoroscopy in the early days of catheterization (approximately 1960-1970) resulted in blurred images during the rapid motion phase.

This led to the development of the “grid control” pulse x-ray system, by Keleket X-Ray Corporation and General Electric Corporation, and the Philips® “cine pulse” system. Both systems allowed x-ray pulsed exposures as short as 1 millisecond. This “froze” the cardiac image similar to a fast shutter on a camera, by using a short x-ray pulse or flash exposure.

Dr. Sven Paulin, Dr. Melvin Judkins and others studied this problem from an image quality perspective, and an exposure of about 0.008 sec was determined to be about the maximum possible in the adult heart, with infants requiring down to 0.001 sec. See, e.g., “Assessing the Severity of Coronary Lesions with Angiography”, Sven Paulin, M.D., Ph.D., N Engl J Med 1987; 316:1405-1407, May 28, 1987.

While this was in general satisfactory up until about 2005, the short exposures required a high power x-ray pulse, at 30 kW to 85 kW, to provide enough total x-ray quanta output in such a short time; this is to be compared to only 0.3 kW (300 watts) for continuous fluoroscopy. This high power caused the x-ray tube focal spot to tend to be larger than optimal (i.e., 0.6 mm or more), to avoid melting the anode. This rather large focus or x-ray source can cause geometric blurring of the images, even on a still heart, when used with improved higher resolution image receptors. Recent additions of radiation dose-saving metallic x-ray spectrum filters further aggravate this tube loading problem, as they require doubling (at least) the power again, due to their absorption of x-ray photons.

The tradeoff of a large x-ray focus was acceptable with rather low resolution (e.g., 2 lp/mm) detector systems, but as detectors have improved it has become more limiting, and will become more so in the future. One would like to use a 0.3 mm or 0.4 mm x-ray tube focal spot to achieve sharper images, up to 5 lp/mm. That however requires a long exposure (i.e., 10 or more msec) to get enough x-ray, causing motion blurring. Note there is little possibility of trade-off in the power loading parameter as the tungsten anode melt temperature is fixed.

Another related problem involves an increasing use of rotational 2-D angiography and reconstruction of the acquired data sets into 3-D images; this process entails taking a series of 2-D images approximately every one degree on a rotating gantry and reconstructing the data as a volume. It is not a CT (computerized tomography) data set, in the usual sense of high contrast sensitivity cross-section data, as CT generally uses continuous fan beam radiation, whereas this technique uses rapid successive short “flash” 2-D or area exposures of about 10 msec each. Each image is a complete instantaneous one, in and of itself, and requires no reconstruction or computer processing to view. This important point is brought up to distinguish this rotational acquisition of complete 2-D flash images from many pre-existing ideas about trying to solve a similar problem with blurred cardiac images in CT devices. CT devices present a totally different and inherent to CT problem, in that the acquisitions are long and will span significant gantry motion as well as heart motion. Applicant's invention, described later in this application, is not related to CT devices at all, and prior art involving CT is not applicable.

The CT approach will always be inherently limited, as even with 64 or 256 slice CT machines, as successive slice groups are spaced in time by about the 0.8 second it takes to record the data as the CT moves ahead one acquisition width along the body (one turn of CT gantry). This acquisition time, even if the number of slices is sufficient to cover the heart in one turn, is also required to be at least the number of fractional seconds it takes the gantry to move through the acquisition angle, which is limited by gantry centripetal forces to about 0.5 second. The heart moves in the interim period, between successive acquisitions along the long axis of the body, and also during each acquisition rotation of the CT gantry.

While “flash 2-D” approaches as described herein, and in U.S. Pat. No. 5,408,521, do not suffer the latency and slow acquisitions of CT gantries within each image, (as the gantry moves less than 1 degree during the acquisition) some of those rotational 2-D flash images are still blurred for biological speed or motion reasons during the rapid phase of the heart motion. This bad data propagates through the reconstruction; to correct this, elaborate correction algorithms are needed, e.g., to spatially shift the data. Even more common, the bad 2-D data set from heart motion is presently deleted, wasting the radiation used on the patient.

Accordingly, it is a primary object of the present invention to provide a method for removing motion from non-CT cardiac angiographic or fluoroscopic x-ray 2-D sequential images.

It is a more specific object to remove such motion by actively deleting or skipping exposure of certain 2-D flash image acquisitions during rapid heart motion, the latter to reduce x-ray exposure.

### SUMMARY OF INVENTION

Applicant has disclosed a method for removing motion from non-CT cardiac angiographic or fluoroscopic x-ray 2-D sequential images, without necessarily using data prediction techniques as is done in sequential CT imagery. Applicant's results are achieved by actively deleting or skipping exposure of certain 2-D flash image acquisitions during rapid heart motion, the latter to reduce x-ray exposure.

Applicant's new concept is to acquire 2-D cardiac fluoroscopic images with a pulsed system as is done now, but with the potential of longer allowed exposures to allow smaller focal points, and an option to stop instantaneously the acquisition pulses if the heart begins to move. This can be done by various known methods of monitoring the ECG waveform, in particular the R wave and R wave interval. Note that no predictive aspects are generally needed, although they can be used, in that the rapid firing rate inherent in the described 2-D flash mode (i.e., 15-30 FPS) lends itself to being interrupted instantly, unlike CT systems which must be synchronized to gantry and reconstruction requirements and cannot be arbitrarily stopped.

Once the 2-D acquisition sequence is momentarily stopped, the associated computer system displays the last acquired image or images repetitively to the physician until the heart motion has stopped, at which time newly acquired data is again displayed. Thus, the observer sees a continuous, steady image and radiation is saved, and much longer exposures from smaller focal spots can be used for sharper images, the intent of this process.

### BRIEF DESCRIPTION OF DRAWINGS

FIG. 1 depicts a series of x-ray bursts from an x-ray tube about 10-15 milliseconds long for each pulse;

FIG. 2 shows the x-ray bursts of FIG. 1 but with two removed pulses in phantom;

FIG. 3 shows the x-ray bursts of FIG. 2 but with the phantom pulses removed;

FIG. 4 discloses a flow chart of Applicant's preferred method for removing motion from non-CT cardiac angiographic or fluoroscopic x-ray 2-D sequential images;

FIG. 5 shows a schematic of Applicant's preferred apparatus for carrying out the method; and

FIG. 6 depicts a patient's beating heart between a receptor and x-ray source of an x-ray machine.

### DETAILED DESCRIPTION OF PREFERRED EMBODIMENT(S)

Applicant has disclosed a method for removing motion from non-CT cardiac angiographic or fluoroscopic x-ray 2-D sequential images by actively deleting or skipping exposure of certain 2-D flash image acquisitions during rapid heart motion, the latter to reduce x-ray exposure. Longer temporal exposures are possible, so that small focal spots can be used, resulting in geometrically sharper images. Such sharpness can be critical to correctly assessing stent deployment and cardiac vessel geometry.

As used herein, the term “non-CT” means “not computer tomography”.

Applicant's method is only applicable to flash 2-D acquisitions or conventional fluoroscopy. It is inapplicable to CT type x-ray devices. Such CT types already pause data acquisitions (i.e., sequential images) by synchronizing with the electrocardiograph (a.k.a. ECG or EKG), requiring data prediction by either predictive algorithms or estimated compensation of motion, as described in U.S. Pat. No. 7,672,490 to Kohler et al. Applicant's method uses neither predictive algorithms nor estimated compensation of motion.

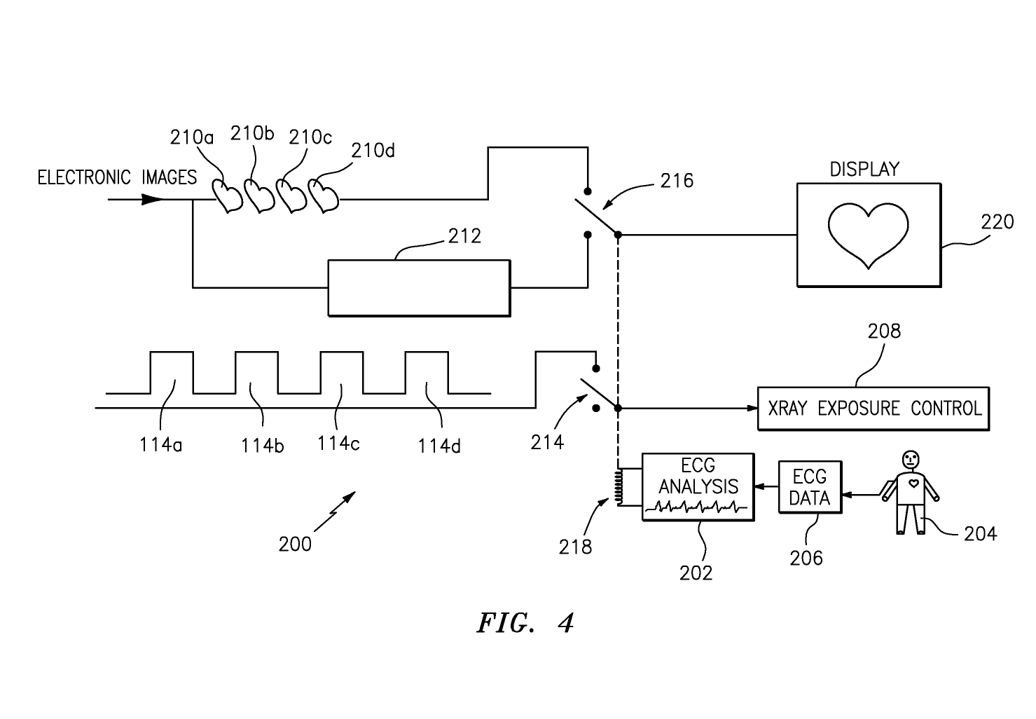

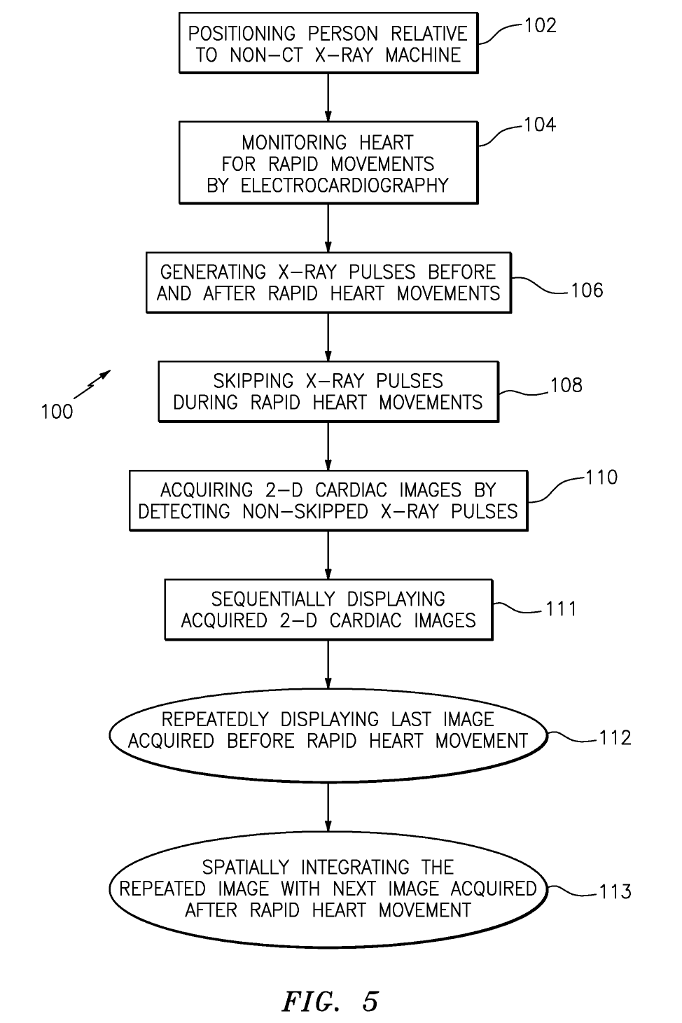

As best shown in FIG. 4, Applicant's preferred method 100 comprises: positioning a person (step 102) relative to a non-CT type x-ray machine designed for fluoroscopy or angiography, with the person's heart between an x-ray source and a detector (a.k.a. receptor); monitoring rapid movement (e.g., beating) of the person's heart (step 104) by electrocardiography; generating a series of x-ray bursts or “pulses” (i.e., about 5-30 msec per pulse) from the x-ray source (step 106) before and after rapid movements of a person's heart; actively removing or skipping any x-ray pulses occurring during rapid movement of the person's heart (step 108), preferably by switching off the x-ray source, to avoid detecting any images from the skipped x-ray pulses; acquiring (i.e., either angiographic or fluoroscopic) 2-D cardiac images from the remaining non-skipped x-ray pulses by detecting the 2-D cardiac images on the detector (step 110); digitally storing the acquired 2-D cardiac images sequentially on a computer (step 111) or alternatively on a computer chip; and generating sequential (i.e., either angiographic or fluoroscopic) 2-D cardiac images from the non-skipped x-ray pulses by the computer (or chip), wherein the computer repeatedly displays the immediately preceding stored image prior to rapid heart movement (step 112), to avoid a display gap during skipped pulses, and spatially and/or temporarily integrates the repeated image with a subsequently generated next image after the x-ray source is turned back on (step 113). These steps allow seamless displaying before and after heartbeats.

As an additional “narrower” step, Applicant's method can include an option for the x-ray technician or medical provider not to remove or skip any x-ray pulses occurring during movement of the patient's heart. That way, a doctor can still view movement of the patient's heart from x-rays taken, if desired.

Any known process can be used to monitor the ECG waveform, in particular the R wave and R wave interval. Such processes include medical electrodes, also known as EKG electrodes, hooked up to an electrocardiographic analyzer.

As stated at Wikipedia.com:
Electrocardiograph (ECG or EKG . . . ) is a transthoracic interpretation of the electrical activity of the heart over time captured and externally recorded by skin electrodes . . . .
The ECG works mostly by detecting and amplifying the tiny electrical changes on the skin that are caused when the heart muscle “depolarizes” during each heartbeat. At rest, each heart muscle cell has a charge across its outer wall, or cell membrane. Reducing this charge towards zero is called de-polarization, which activates the mechanisms in the cell that cause it to contract. During each heartbeat a healthy heart will have an orderly progression of a wave of depolarisation (sic) that is triggered by the cells in the sinoatrial node, spreads out through the atrium, passes through “intrinsic conduction pathways” and then spreads all over the ventricles. This is detected as tiny rises and falls in the voltage between two electrodes placed either side of the heart . . . .

Note that no predictive data is needed, as the rapid firing rate inherent in the described 2-D flash mode (i.e., 15-30 FPS) lends itself to being interrupted instantly, unlike CT systems which must be synchronized to gantry and reconstruction requirements.

Once acquisition is momentarily stopped, the associated computer system displays the last acquired image or images repetitively to the physician until the heart motion has stopped, at which time newly acquired data is again displayed. Thus, the observer sees a continuous, steady image and radiation is saved, and much longer exposures from smaller focal spots can be used for sharper images.

In a broader sense, Applicant's method of taking cardiac images comprises:

a. positioning a person relative to a non-CT type x-ray machine, designed for fluoroscopy, with the person's heart between an x-ray source and a detector;

b. monitoring beating of the person's heart by electrocardiography;

c. generating x-ray pulses from the x-ray source;

d. actively skipping any x-ray pulses during the monitored beating of the person's heart;

e. generating x-ray pulses from the x-ray source after beating of the person's heart;

f. generating cardiac images from the non-skipped x-ray pulses; and

g. whereby substantial motion is eliminated from the cardiac images without using predictive algorithms and without using estimated compensation of motion.

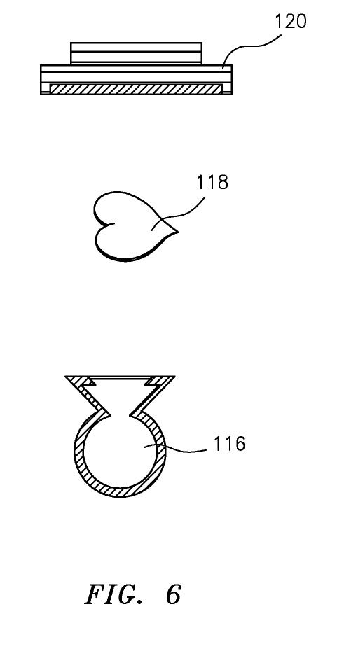

FIG. 1 depicts a series of short x-ray bursts 114a, 114b, 114c, 114d, 114e, 114f from the x-ray tube 116 (shown in FIG. 6), about 5-30 milliseconds long for each pulse. This occurs after a patient's heart 118 has been placed between the x-ray tube 116 and detector 120 (see FIG. 6). The x-rays image the heart 118, and the image is picked up by the detector 120 and converted to an X-Y (i.e., 2-D) image or “x-ray”. This happens at 7-60 images per second, typically.

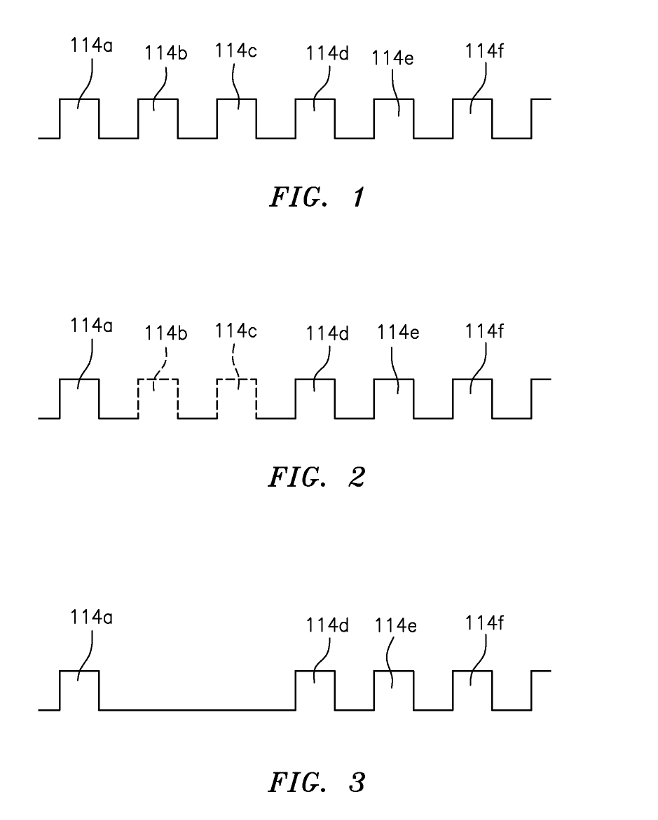

FIG. 2 shows the x-ray bursts 114a-f from FIG. 1, with some pulses 114b, 114c shown in phantom. Those phantom pulses represent sample x-ray pulses acquired during movement of the patient's heart. Such pulses can be skipped so as not to be exposed on the detector 120. FIG. 3 shows the series of pulses from FIG. 2, but with the phantom pulses 114b, 114c skipped, leaving 114a, 114d, 114e, 114f.

FIG. 4 shows Applicant's preferred apparatus/system 200 for display switching from live images to a stored image on command of an ECG analyzer 202, which detects heart motion of person 204 in a known way from the ECG waveform, while x-ray is paused. The preferred apparatus 200 includes: the ECG analyzer 202 for monitoring ECG data 206 obtained from person 204 by skin electrodes (not shown); an x-ray exposure control 208 for optionally any stopping x-ray pulses (e.g., 114a, 114b, 114c, 114d), and resultant image exposures, upon the ECG analyzer 202 sensing rapid movement (e.g., a heartbeat) of the person's heart 118 (see FIG. 6); sample x-ray images (e.g., 210a, 210b, 210c and 210d) of the person's heart 118; a computer 212 for storing an immediately preceding image; and two single pole, double throw switches 214, 216; wherein the ECG analyzer 202 is connected to switch 214 via any suitable hardware (preferably, a coil 218) to open the switch 214 to optionally skip x-ray images acquired during detected rapid movement of the person's heart 118; and a display 220 for displaying sequential cardiac 2-D angiographic or fluoroscopic images.

It is a fact that adequate cardiac categorizations (“heart caths”) were done with non-pulsed television fluoroscopy systems for many years, as the physician could appreciate sufficient information by observing the inter-beat period, without any computer intervention. Such exposures approximated the TV frame rate, or 30 milliseconds, which is very long indeed compared to the 8 millisecond or less optimal exposure now required to deal with motion. The new concept capitalizes on this observation that long exposures are acceptable in the inter-beat period.

It should be understood by those skilled in the art that obvious modifications can be made without departing from the spirit or scope of the invention. For example, the sequential cardiac images can be displayed solely on a detector rather than on a computer. In addition, the method can be used (with additional steps) to help produce 3-D images. Accordingly, reference should be made primarily to the following claims rather than the foregoing description.

I claim:

1. A method of taking fluoroscopic 2-D cardiac images comprising:
a. positioning a person relative to a non-CT type x-ray machine, designed for fluoroscopy, with the person's heart between an x-ray source and a detector;
b. monitoring beating of the person's heart by electrocardiography;
c. generating x-ray pulses from the x-ray source;
d. actively skipping any x-ray pulses during beating of the person's heart;
e. generating x-ray pulses from the x-ray source after beating of the person's heart;
f. generating sequential fluoroscopic 2-D cardiac images from non-skipped x-ray pulses; and
g. whereby motion is eliminated from the sequential images without using predictive algorithms and without using estimated compensation of motion.

2. The method of claim 1 wherein the skipping is achieved by switching off the x-ray source during beating of the person's heart.

3. The method of claim 2 further comprising:
a. storing on a computer the images generated;
b. during beating of the person's heart, repeating for display an immediately preceding, stored image to avoid a display gap while the x-ray source is switched off; and
c. spatially integrating the repeated image with a subsequently generated next image after the x-ray source is turned back on.

4. The method of claim 1 wherein each of the x-ray pulses is substantially 5-30 milliseconds long.

5. A method of taking angiographic 2-D cardiac images comprising:
a. positioning a person relative to a non-CT type x-ray machine, designed for angiography, with the person's heart between an x-ray source and a detector;
b. monitoring beating of the person's heart by electrocardiography;
c. generating x-ray pulses from the x-ray source;
d. actively skipping any x-ray pulses during beating of the person's heart;
e. generating x-ray pulses after beating of the person's heart;
f. generating sequential angiographic 2-D cardiac images from non-skipped x-ray pulses; and
g. whereby motion is eliminated from the sequential 2-D cardiac images without using predictive algorithms and without using estimated compensation of motion.

6. The method of claim 5 wherein the skipping is achieved optionally by switching off the x-ray source during beating of the person's heart.

7. The method of claim 6 further comprising:
a. storing on a computer the images generated;
b. during beating of the person's heart, repeating for display an immediately preceding, stored image to avoid a display gap while the x-ray source is switched off; and
c. spatially integrating the repeated image with a subsequently generated next image after the x-ray source is turned back on.

8. The method of claim 5 wherein each of the x-ray pulses is substantially 5-30 milliseconds long.

9. A method comprising:
a. positioning a person relative to a non-tomography x-ray machine with the person's heart between an x-ray source and a detector;
b. monitoring beating of the person's heart by electrocardiography;
c. generating x-ray pulses from the x-ray source before and after beating of the person's heart;
d. actively skipping any x-ray pulses, occurring during the monitored beating of the person's heart, to prevent displaying any images from the skipped x-ray pulses on a detector;
e. generating cardiac images from the non-skipped x-ray pulses by displaying the cardiac images on the detector; and
f. whereby substantial motion in the cardiac images is eliminated without using predictive algorithms and without using estimated compensation of motion.

10. The method of claim 9 wherein the skipping is achieved by switching off the x-ray source during beating of the person's heart.

11. The method of claim 9 wherein each of the x-ray pulses is substantially 10-15 milliseconds long.
